(19) United States
(12) Patent Application Publication
(10) Pub. No.: US 2020/0394895 A1
(43) Pub. Date: Dec. 17, 2020

(54) Personal Alarm Assembly

(71) Applicant: Jack Frazier, Sanford, FL (US)

(72) Inventor: Jack Frazier, Sanford, FL (US)

(21) Appl. No.: 16/441,410

(22) Filed: Jun. 14, 2019

(51) Int. Cl. G08B 25/01; G08B 27/00; H04W 4/90; H04W 4/029

(52) U.S. Cl. CPC G08B 25/016; H04W 4/029; H04W 4/90; G08B 27/001

(57) ABSTRACT

A personal alarm assembly includes a housing that is carried by a user. A plurality of speakers is each coupled to the housing. Each of the speakers emits an audible alarm outwardly from the housing when the speakers are turned on to alert a bystander to a threat posed to the user. A transceiver is positioned within the housing. The transceiver is in wireless communication with a global positioning system (gps) and an extrinsic communication network. In this way the transceiver can place a call for help to emergency responders and communicate the physical location of the housing to the emergency responders. An activation button is movably coupled to the housing. Each of the speakers and the transceiver is turned on when the activation button is depressed.

### CROSS-REFERENCE TO RELATED APPLICATIONS STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to alarm devices and more particularly pertains to a new alarm device for facilitate a user to call for help from bystanders and from emergency responders when the user feels threatened.

### BRIEF SUMMARY OF THE INVENTION

An embodiment of the disclosure meets the needs presented above by generally comprising a housing that is carried by a user. A plurality of speakers is each coupled to the housing. Each of the speakers emits an audible alarm outwardly from the housing when the speakers are turned on to alert a bystander to a threat posed to the user. A transceiver is positioned within the housing. The transceiver is in wireless communication with a global positioning system (gps) and an extrinsic communication network. In this way the transceiver can place a call for help to emergency responders and communicate the physical location of the housing to the emergency responders. An activation button is movably coupled to the housing. Each of the speakers and the transceiver is turned on when the activation button is depressed.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a personal alarm assembly according to an embodiment of the disclosure.

FIG. 2 is a schematic view of an embodiment of the disclosure.

FIG. 3 is a perspective phantom view of an alternative embodiment of the disclosure.

FIG. 4 is a perspective in-use view of an alternative embodiment of the disclosure.

FIG. 5 is a right side phantom view of an alternative embodiment of the disclosure.

### DETAILED DESCRIPTION OF THE INVENTION

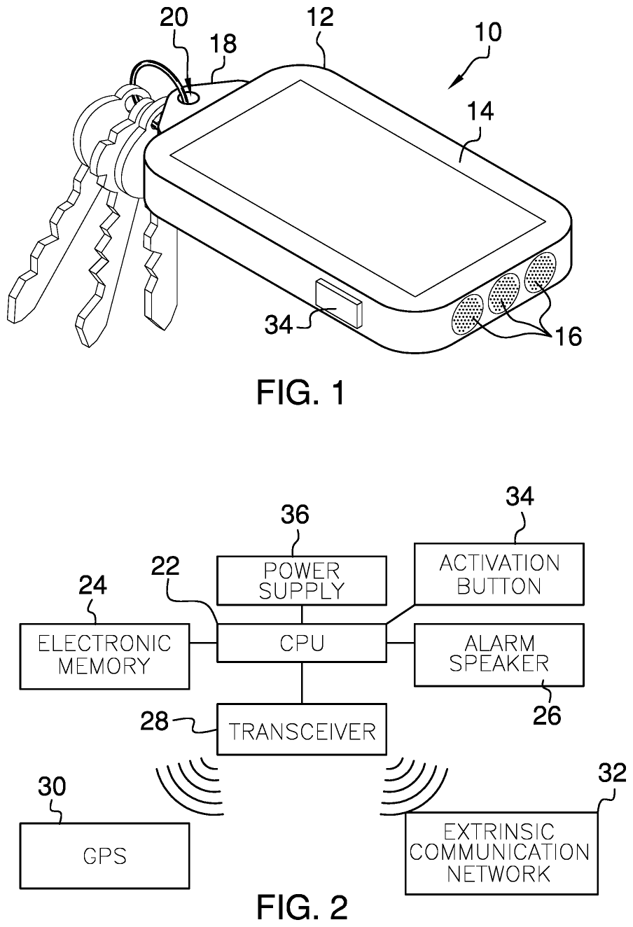

With reference now to the drawings, and in particular to FIGS. 1 through 5 thereof, a new alarm device embodying the principles and concepts of an embodiment of the disclosure and generally designated by the reference numeral 10 will be described.

As best illustrated in FIGS. 1 through 5, the personal alarm assembly 10 generally comprises a housing 12 that is carried by a user. The housing 12 has an outer wall 14 and the outer wall 14 has a plurality of speaker openings 16 each extending into an interior of the housing 12. The housing 12 includes a tab 18 extending away from the outer wall 14 and the tab 18 has an aperture 20 extending therethrough. The aperture 20 can insertably receive a key ring or the like for carrying the housing 12.

A control circuit 22 is positioned within the housing 12 and the control circuit 22 receives an alert input. An electronic memory 24 is positioned within the housing 12 and the electronic memory 24 is electrically coupled to the control circuit 22. The electronic memory 24 stores data comprising audible sounds. The audible sounds include a first phrase comprising a human voice yelling the word “help” multiple times. The first phrase is loaded into the electronic memory 24 when the housing 12 is intended to be carried by an adult male, teenagers or children. The audible sounds include a second phrase comprising a human voice screaming followed by the word “help” is yelled multiple times. The second phrase is loaded into the electronic memory 24 when the housing 12 is intended to be carried by an adult female, teenagers or children. The electronic memory 24 may comprise RAM memory or other similar type of miniaturized, electronic data storage.

A plurality of speakers 26 is each of the speakers 26 is coupled to the housing 12. Each of the speakers 26 emits an audible alarm outwardly from the housing 12 when the speakers 26 are turned on. In this way each of the speakers 26 can alert a bystander to a threat posed to the user. Each of the speakers 26 is electrically coupled to the control circuit 22 and each of the speakers 26 is turned on when the control circuit 22 receives the alert input. Moreover, each of the speakers 26 is aligned with a respective one of the speaker openings 16 in the housing 12. Each of the speakers 26 may comprise an electronic speaker that has an operational volume of at least 120.0 db.

A transceiver 28 is positioned within the housing 12 and the transceiver 28 is electrically coupled to the control circuit 22. The transceiver 28 is in wireless communication with a global positioning system 30 (gps) when the control circuit 22 receives the alert input. In this way the transceiver 28 can receive the physical location of the housing 12 from the gps 30. Additionally, the transceiver 28 is in wireless communication with an extrinsic communication network 32 when the control circuit 22 receives the alert input. Thus, the transceiver 28 can place a call for help to emergency responders and also communicate the physical location of the housing 12 to the emergency responders.

The extrinsic communication network 32 may be a cell phone network or the like and the emergency responders may be local police that are contacted via 911. The transceiver 28 may comprise a radio frequency transceiver or the like. Additionally, the transceiver 28 may employ Bluetooth communication protocols. In this way the transceiver 28 may be capable of being synched with a smart phone or the like. Thus, the smart phone may facilitate gps communication and the smart phone may contact the emergency responders when the control circuit 22 receives the alert input.

An activation button 34 is movably coupled to the housing 12. The control circuit 22 receives the alert input when the activation button 34 is depressed. A power supply 36 is coupled to the housing 12. The power supply 36 is electrically coupled to the control circuit 22 and the power supply 36 comprises at least one battery 38.

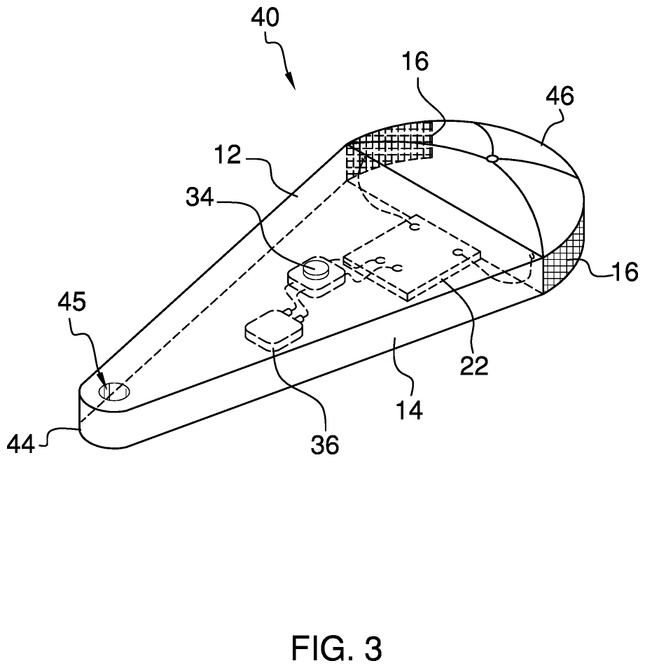

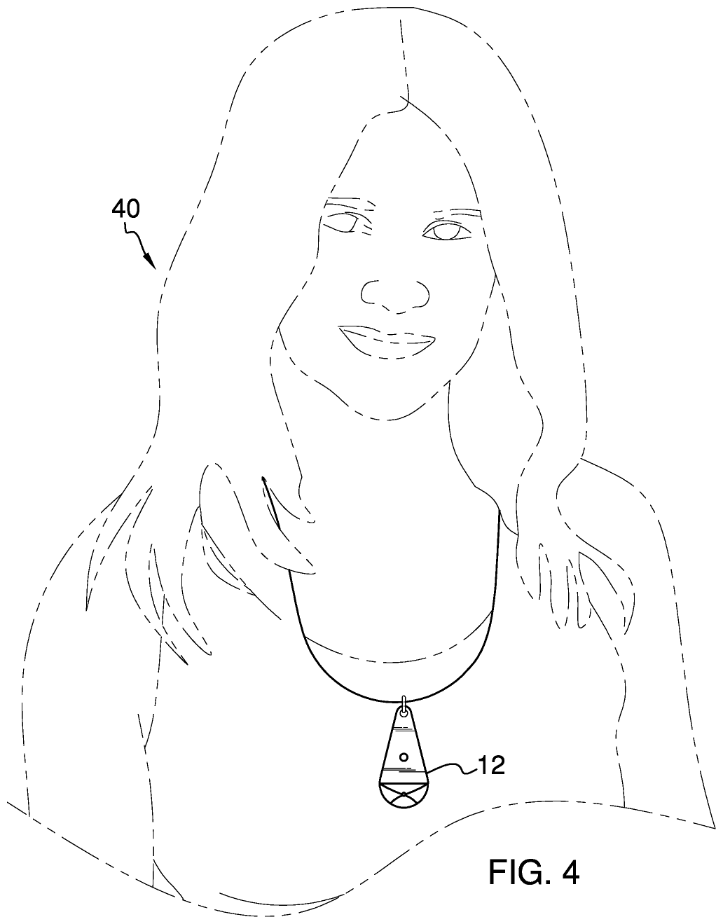

In an alternative embodiment 40 as shown in FIGS. 3 and 4, the outer wall 14 of the housing 12 has a front side 42 and a back side 44. The outer wall 14 tapers to a blunt point at the back side 44 and the front side 42 is concavely arcuate with respect to the back side 44. Additionally, the outer wall 14 flares outwardly between the back side 44 and the front side 42. Each of the speaker openings 16 are positioned on the front side 42. Moreover, the speaker openings 16 are spaced apart from each other on the front side 42.

Continuing in the alternative embodiment 40, the housing 12 has a suspension aperture 45 extending through a top side 46 and a bottom side 48 of the housing 12. A necklace or the like can be extended through the suspension aperture 45 for wearing the housing 12 around the user's neck. The suspension aperture 45 is positioned adjacent to the back side 44 of the outer wall 14 of the housing 12.

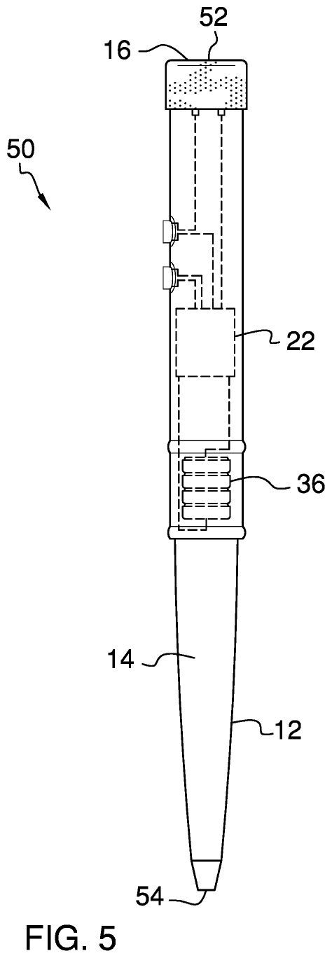

In an alternative embodiment 50 as shown in FIG. 5, the housing 12 has a top end 52 and a bottom end 54. The housing 12 is elongated between the top end 52 and bottom end 54. Additionally, the outer wall 12 of the housing is arcuate about an axis extending through the top end 52 and the bottom end 54 such that the housing 12 has a tubular shape. Each of the speaker openings 16 are positioned on the top end 52.

In use, the housing 12 is carried by the user and the user depresses the activation button 34 when the user feels threatened by a potential assailant or is otherwise under duress. Thus, the speakers 26 emit the audible alarm to alert bystanders to the threat facing the user. Additionally, the transceiver 28 communicates with the gps 30 to receive the physical location of the housing 12. The transceiver 28 additionally places a call for help with the emergency responders and the transceiver 28 communicates the physical location of the housing 12 to the emergency responders. In this way the potential assailant can be deterred with the audible alarm, bystanders are alerted and emergency responders are alerted for an appropriate response. Each of the speakers 26 and the transceiver 28 are turned off when the activation button 34 is depressed a second time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A personal alarm assembly being configured to emit an audible alarm and contact emergency responders when a user feels threatened or in danger, said assembly comprising:
a housing being carried by a user;
a plurality of speakers, each of said speakers being coupled to said housing, each of said speakers emitting an audible alarm outwardly from said housing when said speakers are turned on wherein each of said speakers is configured to alert a bystander to a threat posed to the user;
a transceiver being positioned within said housing, said transceiver being in wireless communication with a global positioning system (gps) wherein said transceiver is configured to receive the physical location of said housing from the gps, said transceiver being in wireless communication with an extrinsic communication network wherein said transceiver is configured to place a call for help to emergency responders and to communicate the physical location of said housing to the emergency responders; and
an activation button being movably coupled to said housing, each of said speakers and said transceiver being turned on when said activation button is depressed.

2. The assembly according to claim 1, wherein said housing has an outer wall, said outer wall having a plurality of speaker openings each extending into an interior of said housing.

3. The assembly according to claim 2, further comprising a control circuit being positioned within said housing, said control circuit receiving an alert input.

4. The assembly according to claim 3, further comprising an electronic memory being positioned within said housing, said electronic memory being electrically coupled to said control circuit, said electronic memory storing a data comprising audible sounds, said audible sounds including a first phrase comprising a human voice yelling the word “help” multiple times, said audible sounds including a second phrase comprising a human voice screaming followed by the word “help” being yelled multiple times.

5. The assembly according to claim 3, wherein each of said speakers is electrically coupled to said control circuit, each of said speakers being turned on when said control circuit receives said alert input, each of said speakers being aligned with a respective one of said speaker openings in said housing.

6. The assembly according to claim 2, further comprising a power supply being coupled to said housing, said power supply being electrically coupled to said control circuit, said power supply comprising at least one battery.

7. A personal alarm assembly being configured to emit an audible alarm and contact emergency responders when a user feels threatened or in danger, said assembly comprising:
a housing being carried by a user, said housing having an outer wall, said outer wall having a plurality of speaker openings each extending into an interior of said housing;
a control circuit being positioned within said housing, said control circuit receiving an alert input;
an electronic memory being positioned within said housing, said electronic memory being electrically coupled to said control circuit, said electronic memory storing a data comprising audible sounds, said audible sounds including a first phrase comprising a human voice yelling the word “help” multiple times, said audible sounds including a second phrase comprising a human voice screaming followed by the word “help” being yelled multiple times;
a plurality of speakers, each of said speakers being coupled to said housing, each of said speakers emitting an audible alarm outwardly from said housing when said speakers are turned on wherein each of said speakers is configured to alert a bystander to a threat posed to the user, each of said speakers being electrically coupled to said control circuit, each of said speakers being turned on when said control circuit receives said alert input, each of said speakers being aligned with a respective one of said speaker openings in said housing;
a transceiver being positioned within said housing, said transceiver being electrically coupled to said control circuit, said transceiver being in wireless communication with a global positioning system (gps) when said control circuit receives said alert input wherein said transceiver is configured to receive the physical location of said housing from the gps, said transceiver being in wireless communication with an extrinsic communication network when said control circuit receives said alert input wherein said transceiver is configured to place a call for help to emergency responders and to communicate the physical location of said housing to the emergency responders;
an activation button being movably coupled to said housing, said control circuit receiving said alert input when said activation button is depressed; and
a power supply being coupled to said housing, said power supply being electrically coupled to said control circuit, said power supply comprising at least one battery.

8. The assembly according to claim 7, wherein said outer wall of said housing has a front side and a back side, said outer wall tapering to a blunt point at said back side, said front side being concavely arcuate with respect to said back side, said outer wall flaring outwardly between said back side and said front side, each of said speaker openings being positioned on said front side, said speaker openings being spaced apart from each other on said front side, said housing having a suspension aperture extending through a top side and a bottom side of said housing wherein said suspension aperture is configured to have a necklace extended therethrough for wearing said housing around the user's neck, said suspension aperture being positioned adjacent to said back side of said outer wall of said housing.

9. The assembly according to claim 7, wherein said housing has a top end and a bottom end, said housing being elongated between said top and bottom ends, said outer wall of said housing being arcuate about an axis extending through said top end and said bottom end such that said housing has a tubular shape.

10. The assembly according to claim 9, wherein said speaker openings are positioned on said top end.
